(19) United States
(12) Patent Application Publication
(10) Pub. No.: US 2008/0005359 A1
(43) Pub. Date: Jan. 3, 2008

(54) Method and apparatus for OS independent platform based network access control

(76) Inventors: Hormuzd M. Khosravi, Portland, OR (US); Dylan Larson, Portland, OR (US); Alan D. Ross, Shingle Springs, CA (US); Uri Blumenthal, Fair Lawn, NJ (US); Ahuva Kroizer, Jerusalem (IL); Avigdor Eldar, Jerusalem (IL); Karanvir Grewal, Hillsboro, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/480,629

(22) Filed: Jun. 30, 2006

(51) Int. Cl. G06F 15/16

(52) U.S. Cl. 709/250

(57) ABSTRACT

Secure enterprise network communication technology provides improved authentication prior to granting network access of enterprise host platforms with the network devices via a backend infrastructure.

### TECHNICAL FIELD

Presented embodiments relate to the fields of data processing and data communication. More particularly, various embodiments relate to techniques for exchanging signed platform posture and policy information to control network access, in an operating system (OS) independent manner.

### BACKGROUND

The proliferation of computer viruses and/or worm attacks in combination with the tendency for many of these malware mechanisms (e.g., worms, viruses, Trojan horses, rootkits) to propagate into corporate networks reinforces the movement for industry-wide development of network security measures to ensure that unauthorized and incompliant devices are not allowed access to various network assets. One manifestation of these efforts can be seen in the various proprietary and/or standards-based solutions for operating systems to measure various pertinent attributes of a host device. In an endeavor to eliminate, isolate, and reduce the impact and/or effects of malware, these measured attributes of a host device are now often evaluated, with the assistance of operating systems, before allowing that host device to connect to a protected network.

To that end, Network Access Control (NAC) technology is being developed to provide for enterprise platform security from host devices requesting network access. In a typical Network Access Control protocol exchange, a host device or access requestor provides data to an enterprise policy server to seek access to a network. The host device typically initiates a network connection (e.g., via IEEE 802.1x EAP-type protocol as defined in the IEEE 802.1X standard, IEEE std. 802.11X-2001, published Jul. 13, 2001) to a Network Access Device (NAD). This initial access request may be redirected to a policy decision point (PDP) in the network, thereby communicating the intent of the host device to connect to the network. Control channel connection requests are ultimately routed to a policy server equipped to make authorization decisions on network access requests, based on an administrative policy. Once a decision is made, a NAD or Policy Enforcement Point (PEP) controls if and how the host device is allowed onto the network.

Unfortunately, sophisticated malware may even attempt to intercept and alter transmissions within the operating system of the host device in an attempt to cloak their presence from network detection. Other malware is designed to intercept and to alter network authentication/access requests so as to appear to report uninfected results, at least until the network connection is activated by the operating system of the host device.

### BRIEF DESCRIPTION OF THE DRAWINGS

The various embodiments will be described by way of exemplary configurations, but not limitations, illustrated in the accompanying drawings in which like references denote similar elements, and in which:

FIG. 1 illustrates a block diagram of operating system independent secure network access by a host platform coupled with different network components in accordance with at least one embodiment;

FIG. 2 illustrates a multi-phase signature authentication exchange between various network components, in accordance with at least one embodiment;

FIG. 3 illustrates a flow diagram view of a portion of the operations of a host platform as presented in FIG. 1 in further detail, in accordance with various embodiments;

FIG. 4 illustrates a flow diagram view of a portion of the operations of a remote device as presented in FIG. 1 in further detail, in accordance with various embodiments;

FIG. 5 illustrates a flow diagram view of a portion of the operations of a host platform as presented in FIG. 1 in further detail, in accordance with various embodiments; and

FIG. 6 illustrates a block diagram of secure network access by various client platforms coupled with a network domain, in accordance with at least one embodiment.

### DETAILED DESCRIPTION

Various embodiments, described below, have been developed in response to the current state of the art and, in particular, in response to the previously identified problems and needs of secure authentication and authorization that have not been fully or completely solved by currently available authentication systems and protocols for distributed network devices. Embodiments provide a method to increase authentication security and thereby reduce time, power, and computational cycles required for a client device to obtain access to a network. In at least one embodiment, a client device attests to platform information by signing the data with a key known to the client and the policy server, in an OS independent manner, without fundamentally impacting the underlying security frameworks being used by the network. The policy server (e.g., a PDP) can validate the posture using a reciprocal key to ensure that the posture data has not been modified en route. Signed platform posture information (generated in an OS independent manner) may be distributed independent of the OS to a posture validation server to bypass the performance of a full and thorough re-evaluation of the host platform device, so long as the host platform device continues to maintain a valid key and to satisfy network security criteria. Moreover, signed platform posture information may also be divided into at least one data fragment and individually validated. Upon determining that each individual data fragment may be authenticated, policy information associated with the received platform posture information may be collated from at least one server backend plug-in and transmitted to the qualified host platform device.

In the following detailed description, reference is made to the accompanying drawings which form a part hereof wherein like numerals designate like parts throughout, and in which are shown, by way of illustration, specific embodiments. It is to be understood that other embodiments may also be utilized and structural or logical changes may be made without departing from the scope of the invention. In other instances, well-known circuits, structures and techniques have not been shown in detail in order not to obscure the understanding of this description. Therefore, the following detailed description is not to be taken in a limiting sense, and the scope of the various embodiments is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but they may. The phrase “A/B” means “A or B”. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional.

Reference in the specification to a “digital device” means that a particular feature, structure, or characteristic, namely device operable programmability or the ability for the device to be configured to perform designated functions, is included in at least one embodiment of the digital device as used herein. Typically, digital devices may include general and/or special purpose computing devices, such as a laptop computer, a personal digital assistant (PDA), mobile phone, and/or console suitably configured for practicing the present invention in accordance with at least one embodiment. The terms “client device” and “host device” are often synonymously used herein and are interchangeable with digital device as previously defined. Reference in the specification to “remote device” means a network device electronically coupled to the digital device or host platform via a network interface and suitably configured for practicing the present invention in accordance with at least one embodiment. Exemplary network devices may include general and/or special purpose computing devices, such as a network access policy decision point (PDP), a Policy Enforcement Point (PEP), a gateway, a router, a bridge, a switch, a hub, a repeater, and/or a server.

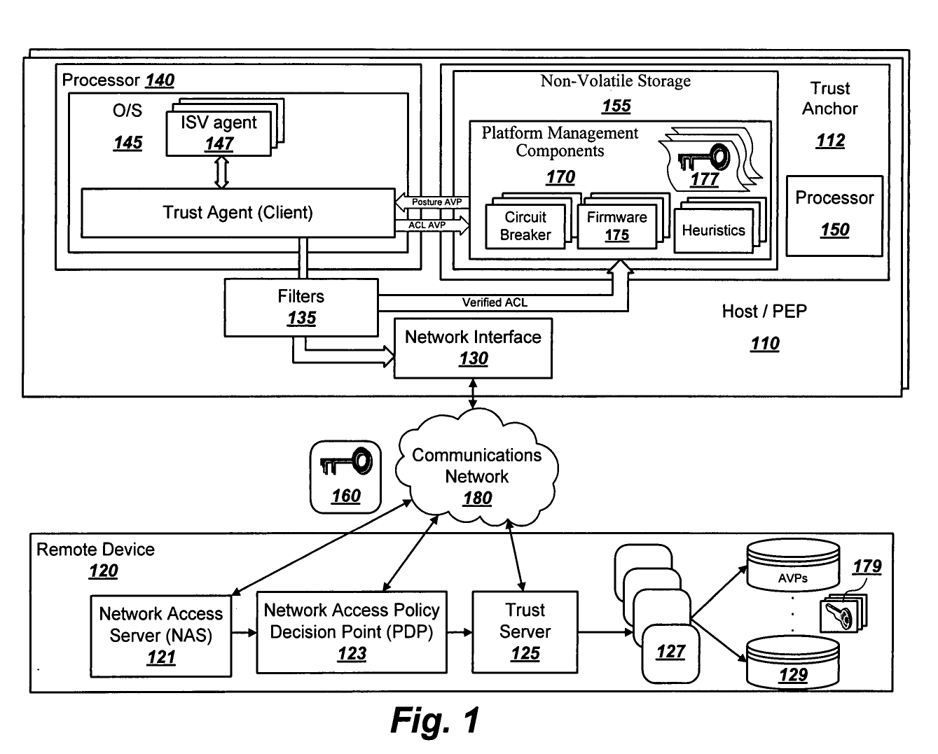

Referring to FIG. 1, a high-level block diagram illustrating an overview of the invention, in accordance with various embodiments, is shown. Embodiments describe a protocol for conveying network access requests from the at least one host platform device 110 including, where appropriate, signed platform posture information 160, generated independent of an OS of the platform, to the at least one remote device 120. The at least one host platform device 110 subsequently receives network access determinations and/or related policy information, if any, based in part on the transmitted signed platform posture information 160, which can then be enforced on the at least one host platform device 110. One embodiment uses an instantiation of an Extensible Authentication Protocol type-length-value (EAP-TLV) protocol infrastructure, a publicly accessible IEEE 802.1X EAP-type protocol, to facilitate a secure exchange between the at least one host platform device 110 and the at least one remote device 120. The at least one remote device 120 including devices as previously described

The illustrated host platform device 110 includes a network interface 130, a first processor 140, a second processor 150, an operating system 145, one or more software components 147, and one or more platform management components 170, operationally coupled to each other as shown. The one or more software components 147, such as independent software vendor (ISV) agents, are adapted to be executed by the first processor 140 under the direction of the operating system 145.

The platform management components 170 are adapted to be executed by the second processor 150, independent of the operating system 145. The platform management components 170 are also configured to determine platform posture information independent of the operating system 145 and to generate signed platform posture information 180 based on a posture signature key 177 to obtain network access control policy information for the host platform device 110.

The network interface 130, coupled with the first processor 140 and/or the second processor 150, is configured to communicate with the at least one remote device 120 across communication network 180. The network interface 130 is configured to transmit the signed platform posture information 160 (generated independent of the OS) to the at least one remote device 120 and to receive, via the at least one network interface 130, policy information 127 sent in response by the remote device 120. The communication network 180 may include at least one gateway, router, bridge, switch, hub, repeater, and/or server. Additional components may be included in various embodiments of the host platform device 110 which are not illustrated in FIG. 1.

In various embodiments, the platform management components 170 determine and sign platform posture information 160 of the host platform device 110 via firmware agents 175, independent of operating system 145. In one embodiment, firmware agents 175 exhibit at least two characteristics: 1) no code executing within the host operating system 145 can modify or tamper with firmware agent code, prevent firmware agent code from running, or circumvent operation of the firmware agent 175; and 2) firmware agents 175 have exclusive access to certain host resources, for example filters 135 associated with the network interface 130 and posture signature keys 177 and unrestricted access to other resources, such as non-volatile storage 155 and associated controllers. In this manner, embodiments may provide a tamper resistant execution environment on host platform device 110 which may allow the trust anchor 112 of host platform device 110 to act as a PEP acting on behalf of the network administrator to restrict or enable network access of the host platform device 110, based on detected operational conditions. In one embodiment, at least some platform operational conditions may be reported to the remote device 120 in the form of signed platform posture information 160.

The signed platform posture information 160 is provided to the remote device 120 via the network interface 130 across communications network 180. In one embodiment, the signed platform posture information 160 includes host posture information and/or firmware posture information. In one embodiment, the signed platform posture information 160 includes at least one posture signature key 177. In one embodiment, one or more platform management components 170 are adapted to determine platform posture information, independent of the operating system. The one or more platform management components 170 are adapted to generate signed platform posture information 160 based on a selected posture signature key 177. The signed platform posture information 160 may be transmitted to the remote device 120 to obtain policy information 127 for the host device. The transmission may be made through the input/output interface of the trust anchor 112 and the networking interface 130 of the at least one host platform 110. The posture signature key 177 of the host system may be stored on either the non-volatile storage 155 or another storage of the at least one host platform 110.

In one embodiment, the posture signature key 177 may either identify whether the host platform device 110 continues to satisfy network security criteria or whether an intervening event may require the host platform device 110 to be re-authenticated. For example, in one embodiment, a key associated with filters 135 may be designated for expiration after a period of time so that they can be securely refreshed by a PDP on a subsequent connection attempt during re-authentication.

In one embodiment, the at least one posture signature key 177 is associated with at least one reciprocal signature key 179 employed by the PDP to validate the received signed platform posture information 160. In one embodiment, the posture signature key 177 is a private key and the reciprocal signature key 179 is a public key. In one embodiment, the host platform device 110 transmits multiple posture signature keys 177 and the remote device 120 validates each of the posture signature keys 177 using a reciprocal signature key 179 associated with that posture signature key 177.

In one embodiment, the host platform device 110 may transmit encrypted posture AVP requests/responses or TLVs to the remote device 120 over an authenticated channel. In similar fashion, the remote device 120 may transmit encrypted AVP requests/responses or TLVs to the host platform device 110. In one embodiment, the signed platform posture information 160 may provide the encryption mechanism for the AVP requests/responses or TLVs.

In one embodiment, the trust anchor 112 may modify the signed platform posture information 160 and thereby authenticate the host platform based on previously received policy information including verified keys and/or access control lists (ACL). The ACL includes one or more constraints related to time of access, network traffic filters, firmware version, and/or firmware operational status.

In various embodiments, the signed platform posture information 160 is transmitted using multiple data fragments to the remote device 120. Each data fragment includes posture information associated with a platform component of the host platform. The signed platform posture information 160 contains information about the posture of various platform components including, but not limited to, the management engine (ME), host Operating System (O/S) 145, software services, hardware components, and any other entity deemed pertinent for evaluation based on administrative policy 127 and capabilities available within a given platform architecture.

The illustrated at least one remote device 120 may include a network access server (NAS) 121, network access policy decision point (PDP) 123, and a trust server 125. The trust server 125 may compare received posture attribute-value pair (AVPs) with administrative policies 127, which may include stored type-length values (TLVs) and/or AVPs 129, to determine whether to allow host platform device 110 to connect to additional network resources.

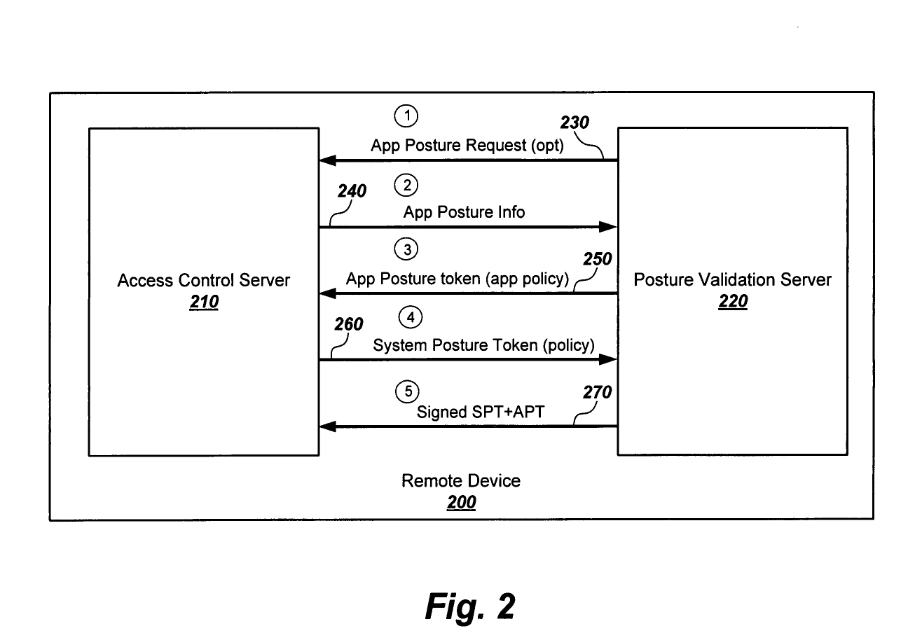

In one embodiment, the received signed platform posture information 160 is verified with at least one reciprocal signature key 179. In one embodiment, the trust server 125 disperses the multiple data fragments in the signed platform posture information 160 to specific server backend plug-in devices, such as the posture validation server as illustrated in FIG. 2.

In one embodiment, the host platform device 110 may receive signed network access control policy information, such as signed AVPs containing instructions for remediation or access control lists (ACLs) to set filters 135. Accordingly, additional remote network devices and/or components may be included in various embodiments of the network which are not illustrated in FIG. 1.

Referring to FIG. 2, a block diagram of a multi-phase signature authentication exchange between various network components, such as an access control server 210 and a posture validation server 220, is illustrated in accordance with at least one embodiment. In one embodiment, the signature authentication exchange includes a signature posture and policy information exchange using a two-phase commit mechanism between a policy decision point (PDP), such as the access control server 210, and a server back-end plug-in, such as the posture validation server 220. In alternate embodiments, other network access authentication protocols and/or mechanisms may be used, as the exchange model is equally applicable across a wide range of connection frameworks.

In one embodiment, the access control server 210 includes at least one PDP. Likewise, in one embodiment, the posture validation server 220 includes at least one server backend plug-in. In one embodiment, the access control server 210 and posture validation server 220 are both separately in communication with a host platform. In one alternate embodiment, the access control server 210 and posture validation server 220 are part of the same network device.

In one embodiment, the posture validation server 220 optionally initiates a first transmission 230 by sending an application posture request to the access control server 210. In a second transmission 240, the access control server 210 transmits application posture information to the posture validation server 220. As previously noted, the second transmission 240 may be triggered by the optional application posture request sent in the first transmission 230. In one embodiment, the second transmission 240 may also be triggered by the expiration of a timer to update information and/or receipt of changed information regarding existing policy and/or posture information on the platform being monitored.

In one embodiment, the posture validation server 220 responds with a third transmission 250 of the two-phase commit exchange by sending an application policy decision. In one embodiment, the third transmission 250 includes an application posture token, which may be associated with the application policy information, that governs access to the access control server 210.

Upon receiving the application posture token, in one embodiment, the access control server 210 initiates a fourth transmission 260 of the exchange to the posture validation server 220 containing a system posture token, which includes policy information. The posture validation server 220 initiates a fifth transmission 270 to the access control server 210 to send signature information, including a signed system policy token and/or a signed application posture token. Upon receipt of the signature information the access control server 210 may send the policy information back to a Policy Enforcement Point (PEP) and/or client.

In another embodiment, the access control server 210 may provide the functionality to sign the overall system policy and verify the posture signature. Signature verification functions may include a wide range of algorithms including at least one of RSA (Rivest Shamir and Adleman), DSA (Digital Signature Algorithm), ECC (Error Correcting Code), DH (Diffie-Hellman), SHA (Secure Hash Algorithm), and AES (Advanced Encryption Standard) for cryptographic signature generation.

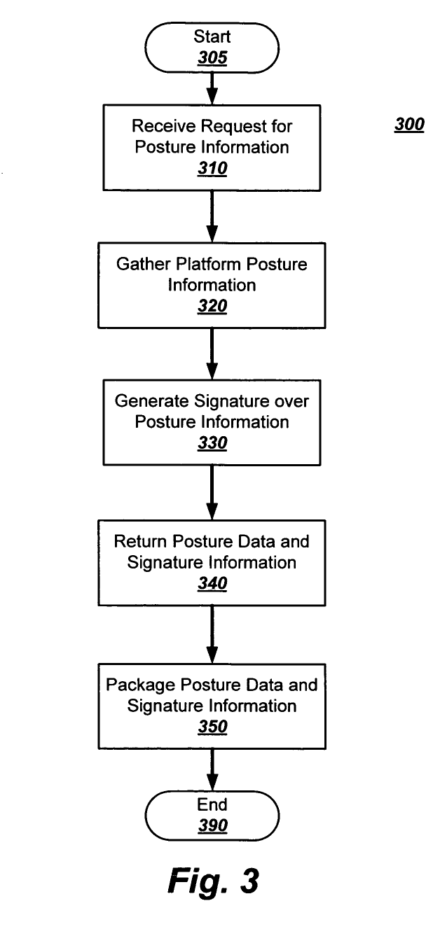

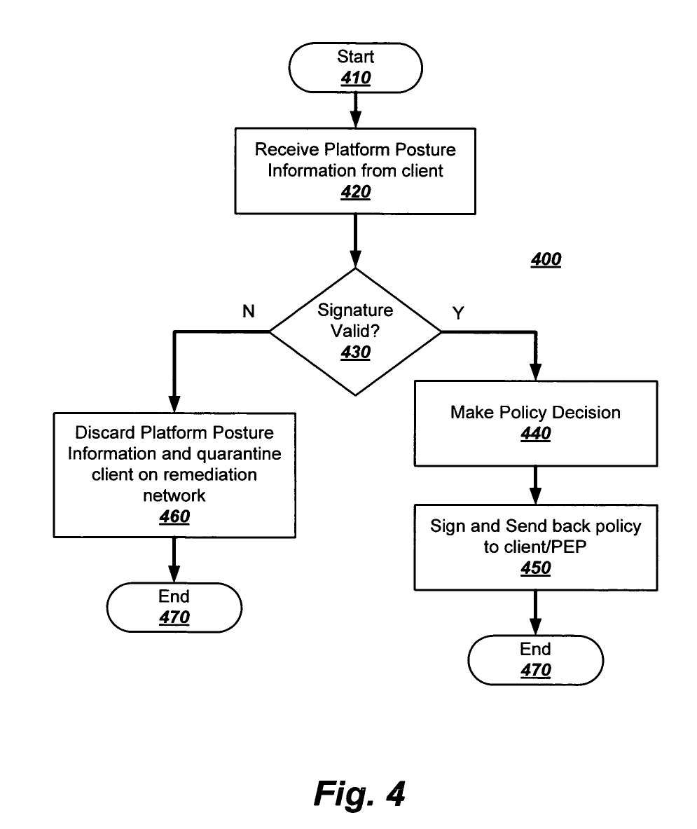

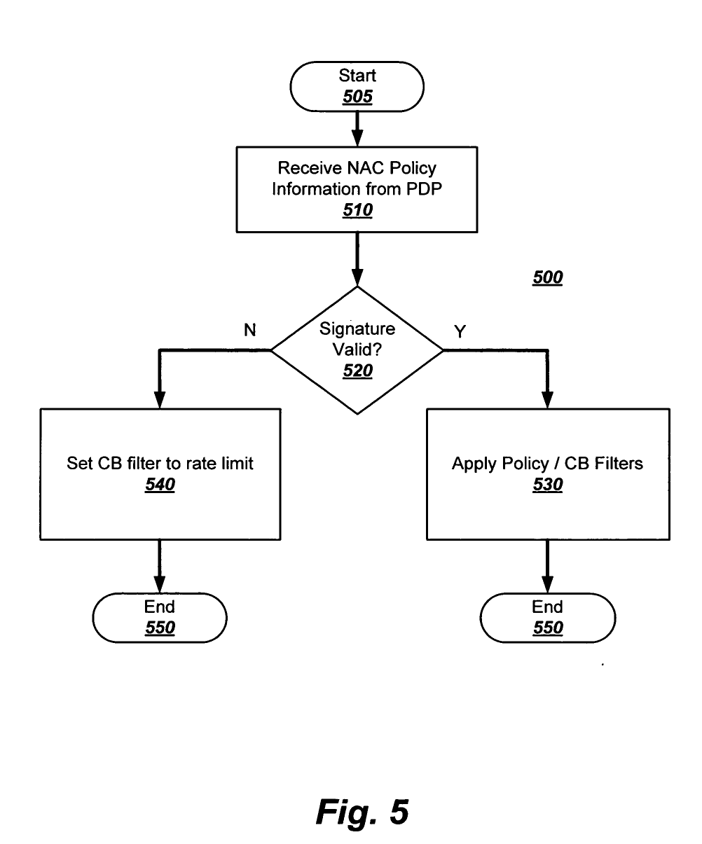

Turning now to FIGS. 3-5, methods, in accordance with various embodiments, are described in terms of computer firmware, software, and hardware with reference to a series of flow diagrams. In various embodiments, portions of the operations to be performed by a host platform device (e.g., FIGS. 3 and 5) and/or remote devices (FIG. 4) may constitute state machines or computer programs made up of computer-executable instructions. These instructions are typically maintained in a storage medium accessible by the host platform device and/or remote devices.

A storage medium includes any mechanism that provides (i.e., stores and/or transmits) information in a form readable by a machine (e.g., a computer). For example, a storage medium includes read only memory (ROM), random access memory (RAM), magnetic disk storage media, optical storage media, flash memory devices, electrical, optical, acoustical or other form of propagated signals (e.g., carrier waves, infrared signals, digital signals), and the like.

Describing the methods by reference to a flow diagram enables one skilled in the art to develop such programs, including instructions to carry out the methods on suitably configured host platforms and/or remote devices. In various embodiments, at least one of the processors of a suitably configured host platform and/or remote device executes the instructions from the storage medium. In various embodiments, the computer-executable instructions may be written in a computer programming language or may be embodied in firmware logic, reconfigurable logic, a hardware description language, a state machine, an application-specific integrated circuit, or combinations thereof. If written in a programming language conforming to a recognized standard, such instructions may be executed on a variety of hardware platforms and may interface with a variety of operating systems.

The present various embodiments are not described with reference to any particular programming language. It will be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of saying that execution of the software by a network device causes the processor of the computer to perform an action or a produce a result.

Referring to FIG. 3, a flow diagram view of a portion of the operations of a host platform device 300 as presented in FIG. 1 is shown in further detail, in accordance with various embodiments. In block 305, the host platform device 300 initiates a platform posture inquiry. A request for posture information is received by the trust anchor of the host platform device 300 in block 310. In one embodiment, the posture request is initiated via a remote device connected via a network connection. In one embodiment, the posture request may be initiated by a change detected by one or more platform management components adapted to determine platform posture information. Alternatively, the posture request may be automatically generated upon the expiration of a status timer.

In response to the received request, the host platform device 300 gathers platform posture information, independent of the platform's operating system in block 320. In one embodiment, one or more platform management components are adapted to determine platform posture information, independent of the operating system.

In block 330, the host platform device 300 generates a signature over the posture information. In one embodiment, the one or more platform management components are adapted to generate signed platform posture information based on a posture signature key, the posture signature key of the host system to be stored on either non-volatile storage of the trust anchor or storage of the host platform device.

In response to the initial request, the host platform device 300 returns posture data and signature information in block 340. In one embodiment, the signed posture information 330 may be used to obtain policy information for the host device through the networking interface of the host platform device 300. In one embodiment, the posture data and signature information is ultimately routed to a policy server which is equipped to make authorization decisions on network access, based on an administrative policy, via a control channel connection.

As previously indicated, the signed platform posture information may be transmitted using multiple data fragments. In one embodiment, each data fragment includes posture information associated with a platform component of the host platform. In one embodiment, the signed platform posture information includes a posture signature and at least one of host posture information and/or firmware posture information of the host device. In one embodiment, the host posture information includes at least one identification selected from the group consisting of platform identification, platform revision identification, Basic Input/Output System (BIOS) revision identification, Extensible Firmware Interface (EFI) revision identification, host operating system revision identification, and Trusted Platform Module capability identification. In one embodiment, the firmware posture information includes one or more parameters selected from the group consisting of an operational mode, a transport layer security (TLS) state, a Crypto enable fuse state, a provisioning state, a network interface state, an IDER state, a Serial over LAN (SoL) state, a firmware (FW) update state, a posture version state, a module version state, a link state, a posture version identification, a vendor identifier, a build date identifier, a posture image size, a number of modules, a module identifier, a module version identification, a module size, and a module flag.

Once the posture data and signature information has been collected, the host platform device 300 packages the posture data and signature information for transmission to a remote device in block 350. As part of the signature information, the host platform device 300 may be configured to provide public keys to the remote device for subsequent policy signature generation and verification. Once the signed posture information is successfully packaged and transmitted, the relevant portion of the operations on the host device 300 may end in block 390.

Referring to FIG. 4, a flow diagram view of a portion of the operations of a remote device 400 as presented in FIG. 1 is shown in further detail, in accordance with various embodiments. In one embodiment, the remote device 400 is a combination of an access control server and/or a server backend plug-in as presented in FIG. 2. The remote device 400 initiates platform posture verification in block 410. Platform posture information is received by the remote device 400 from the client in block 420. The remote device 400 determines whether the signature used with the received platform posture information is valid in query block 430.

In the case of a valid signature, the remote device 400 may make a corresponding policy decision with respect to the access request from the client in block 440. In one embodiment, a valid signature represents a device acceptable to the network and the policy decision determines the type of access that will be granted. Once the policy information has been determined and collected, the remote device 400 signs the applicable policy information and sends the signed policy information back. In one embodiment, the remote device 400 is further adapted to transmit in block 450 the signed policy information to the host client device and/or a policy enforcement point (PEP). In one embodiment, network policy and platform policy are consolidated into the policy information at the remote device 400 using a multi-phase commit process. Once the signed policy information is successfully transmitted, the relevant portion of the operations on the remote device 400 may end in block 470.

Alternatively, if the signature is not found to be valid in query block 430, the remote device 400 may discard the received platform posture information and initiate quarantine procedures to move the client transmitting the invalid posture information to a remediation network in block 460. Once the invalid access request from the client is sent to the remediation network, the relevant portion of the operations on the remote device 400 may end in block 470.

Referring to FIG. 5, a flow diagram view of a portion of the operations of a Policy Enforcement Point (PEP) 500 as presented in FIG. 1 is shown in further detail, in accordance with various embodiments. The PEP 500 initiates a signature validation process in block 505. The PEP 500 receives signed network access control policy information from a PDP in block 510. The PEP 500 determines whether the signature is valid in query block 520. In one embodiment, a public key is used for verification of the signature.

Upon determining that the signature is valid, the PEP 500 may apply the policy information to network access filters on the requesting host platform device, such as callback (CB) filters, in block 530.

Alternatively, in one embodiment, if query block 520 determines that the signature is invalid, the PEP 500 sets a CB filter in block 540 to a limited rate. In one embodiment, the filter may enable certain components to pass to the trust anchor, according to a rate limit, while restricting other components. In one embodiment, the filter is set to pass Extensible Authentication Protocol (EAP) and/or Dynamic Host Configuration Protocol (DHCP) communication on a limited basis. In one embodiment, the transceiving rate is restricted to about one packet per minute. This enables the device to eventually initiate a new access request without burdening the network with excessive access attempts, which may even be the purpose of an infected device.

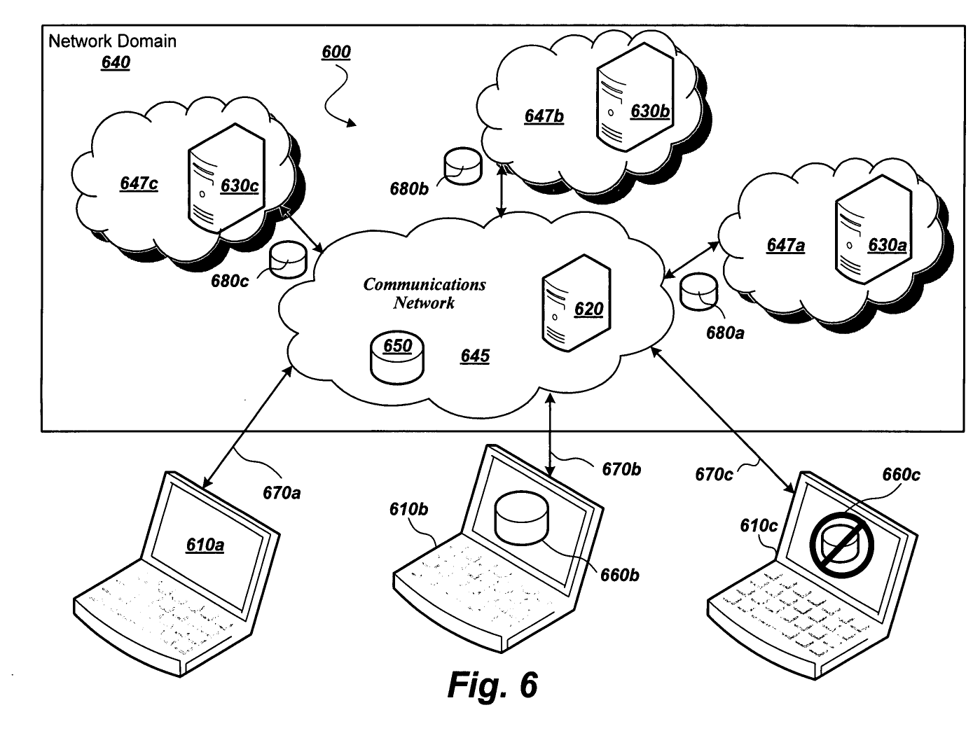

Referring to FIG. 6, a network 600 illustrating various types of secure and unsecured network access in accordance with at least one embodiment is shown. The network 600 includes at least one host device 610, at least one access control server 620, and at least one posture validation server 630. In one embodiment, the at least one host device 610 attempting to access a network domain 640 obtains authorization from the at least one access control server 620 via communications network 645 and/or from the at least one posture validation server 630 via the associated sub-networks 647, if any.

At least three different types of access request are illustrated in FIG. 6. In a first type, the at least one access control server 620 receives an access request 650 to the network domain 640 from a requesting host device 610a which does not include either posture information or signature keys. As such, a standard prolonged network authentication process must be completed with the requesting host device 610a in accordance with a network access authentication protocol, such as an instantiation of the Extensible Authentication Protocol-Flexible Authentication via Secure Tunneling (EAP-FAST) protocol, a publicly accessible EEE 802.1X EAP type protocol. An Internet Engineering Task Force (IETF) informational draft of an exemplary EAP-FAST protocol by Cisco Systems® was first submitted for publication on Feb. 8, 2004 and was posted on Feb. 10, 2004). The EAP-FAST protocol is intended for use with IEEE 802.1X EAP type protocol as defined in the IEEE 802.1X standard, IEEE std. 802.11X-2001, published Jul. 13, 2001. Alternatively, in various embodiments, other network access authentication protocols may be used.

In a second type, the at least one access control server 620 receives an access request 650 to the network domain 640 from a requesting host device 610b which includes either posture information or signature keys. The access request 650 may include signed information 660b associated with the requested access grant of the requesting host device 610. In one embodiment, the signed information 660b may be collected by one or more platform management components executing independent of an operating system on the requesting host device 610. The at least one access control server 620 determines whether to grant the requested network access based at least in part on the received signed information 660b associated with the access request 650. If network access is to be granted, the at least one access control server 620 retrieves what policy information 680, if any, is to govern the network access of the requesting host device 610 based at least in part on the received signed information 660b associated with the access request 650. In one illustrated embodiment, the policy information 680 may be collected and signed by multiple posture validation servers 630a-b. As previously illustrated in FIG. 2, one embodiment uses a two phase commit mechanism to create a secure exchange and convey an application policy token to the access control server 620. In response, the access control server 620 may transmit a system policy token to each of the posture validation servers 630. The system policy token and the application policy token may then be used by the the posture validation servers 630 to sign and return policy information to the at least one access control server 620. Upon receipt of the access determination and/or receipt of the signed policy information, the at least one access control server 620 transmits the result of the network access determination to the PEP and/or the requesting host device 610. In one embodiment, the result of the network access determination includes an authenticated and encrypted payload, if any. The authenticated and encrypted payload may include signed policy information for the requesting host device 610. As previously indicated, in one embodiment, the signed platform posture information associated with the access request 650 may be transmitted using multiple data fragments. In one embodiment, each data fragment includes posture information associated with a specific platform component of the host platform. In one embodiment, the network 600 is able to relay posture information for specific platform components to at least one posture validation server 630. In one embodiment, each posture validation server 630 is dedicated to authenticating and verifying received posture information from the various host devices. Likewise, policy information may be generated at each posture validation server 630 for specific platform components.

In a third type, the at least one access control server 620 receives an access request 650 to the network domain 640 from a requesting host device 610c which includes either invalid posture information or invalid signature keys. In this case, the at least one access control server 620 may discard the received posture information and quarantine the requesting host device 610c to a remediation network. This allows the requesting host device 610c to be authenticated, but alerts the network to potential problems with the device. Alternatively, the invalid signature keys may merely represent the expiration of previously issued authentication and the at least one access control server 620 may merely refresh or validate the requesting host device 610c.

In one embodiment, the at least one access control server 620 includes a network access server, a network policy decision point (PDP), and/or a trust server as previously described in FIG. 1. In one embodiment, the at least one posture validation server 630 includes a server backend plug-in. Each server backend plug-in is responsible for authenticating a separate segment of platform information. The authenticated segments may be combined, once they are returned to a PDP, to form a system policy governing network access for the requesting host device.

Although specific embodiments have been illustrated and described herein, it will be appreciated by those of ordinary skill in the art and others, that a wide variety of alternate and/or equivalent implementations may be substituted for the specific embodiments shown and described without departing from the scope of the present invention. This application is intended to cover any adaptations or variations of the embodiments discussed herein. Therefore, it is manifested and intended that the various embodiments be limited only by the claims and the equivalents thereof.

What is claimed is:

1. An apparatus comprising:
an input/output interface adapted to be coupled to a networking interface of a host device on which the apparatus is designed to be installed, the host device, in addition to the networking interface, to further include a processor coupled with the networking interface, adapted to execute an operating system and one or more software components;
non-volatile storage having one or more platform management components adapted to determine platform posture information and to generate signed platform posture information based on a posture signature key to obtain network access control policy information for the host device, through the input/output interface of the apparatus and the networking interface of the host device, the determining to be performed independent of the operating system and the posture signature key of the host system to be stored on either the non-volatile storage or a storage of the host device; and
a processing core coupled to the input/output interface and the non-volatile storage to operate the one or more platform management components.

2. The apparatus of claim 1, wherein the one or more platform management components is configured to transmit the signed platform posture information, via the at least one network interface, to a remote device and configured to receive, via the at least one network interface, policy information sent in response by the remote device.

3. The apparatus of claim 2, wherein the remote device comprises a network access policy decision point (PDP).

4. The apparatus of claim 3, wherein the posture signature key is associated with a reciprocal signature key employed by the PDP to validate the received signed platform posture information.

5. The apparatus of claim 3, wherein the PDP is further adapted to transmit the policy information to a policy enforcement point (PEP) in addition to the host device.

6. The apparatus of claim 2, wherein the one or more platform management components is further configured to provide public keys, via the at least one network interface, with the remote device for policy signature generation and verification.

7. The apparatus of claim 6, wherein network policy and platform policy are consolidated into the policy information at the remote device using a multi-phase commit process.

8. The apparatus of claim 1, wherein the signed platform posture information includes a posture signature and at least one of host posture information and/or firmware posture information of the host device.

9. The apparatus of claim 8, wherein the host posture information includes at least one identification selected from the group consisting of platform identification, platform revision identification, Basic Input/Output System (BIOS) revision identification, Extensible Firmware Interface (EFI) revision identification, host operating system revision identification, and Trusted Platform Module capability identification.

10. The apparatus of claim 8, wherein the firmware posture information includes one or more parameters selected from the group consisting of an operational mode, a transport layer security (TLS) state, a Crypto enable fuse state, a provisioning state, a network interface state, an IDER state, a Serial over LAN (SoL) state, a firmware (FW) update state, a posture version state, a module version state, a link state, a posture version identification, a vendor identifier, a build date identifier, a posture image size, a number of modules, a module identifier, a module version identification, a module size, and a module flag.

11. A system comprising:
a network interface;
a mass storage device;
a first and a second processor, at least one of the processors being coupled with the network interface and the mass storage device;
memory coupled to at least the second processor and configured to store a posture signature key;
an operating system and one or more software components configured to be executed by the first processor; and
one or more platform management components adapted to be executed by the second processor to determine platform posture information, independent of the operating system, to generate signed platform posture information based on the stored posture signature key and to provide the signed platform posture information to a remote device, via the network interface.

12. The system of claim 11, wherein the one or more platform management components are further configured to transmit the signed platform posture information, via the network interface, to a remote device, and configured to receive, via the network interface, policy information sent in response by the remote device.

13. The system of claim 12, wherein the remote device comprises a network access policy decision point (PDP).

14. The system of claim 13, wherein the one or more platform management components are further adapted to include public keys for policy signature generation and verification as part of the signed platform posture information provided to the PDP via the network interface.

15. The system of claim 11, wherein the posture signature key is associated with a reciprocal signature key, employed on the remote device to validate the received signed platform posture information.

16. A method comprising:
receiving an access request to a network for an apparatus;
receiving signed information associated with access grant of the apparatus collected by the one or more platform management components, independent of an operating system of the apparatus;
determining whether to grant the requested network access based at least in part on the received signed information and, if network access is to be granted, retrieving what policy information, if any, is to govern the network access of the apparatus based at least in part on the received signed information; and
transmitting the result of the network access determination to the apparatus, including an authenticated and encrypted payload, if any.

17. The method of claim 16, wherein determining what policy information, if any, is to govern the network access of the apparatus includes consolidating network policy and platform policy into the governing policy information using a two-phase commit process.

18. The method of claim 16, wherein the receiving of the access request the receiving of the signed information, the determining, and the transmitting are performed at a network access control Server and/or Policy Decision Point (PDP).

19. The method of claim 16, wherein the retrieving policy information includes validating the received signed information with a reciprocal signature key.

20. An article of manufacture comprising:
a storage medium having stored therein a plurality of programming instructions that, when activated by one or more processors of a host electronic device, operate as one or more platform management components, independent of an operating system of the host electronic device, to
maintain a signature key associated with the host electronic device;
determine and maintain platform information associated with a network access grant;
transmit signed, based on the signature key, platform information to a remote device via a network interface of the host electronic device;
receive network access control policy information from the remote device via the network interface, the policy information being provided based at least in part on the transmitted signed platform information and governing access to a network by the host electronic device; and
enforce network access by the host electronic device based at least in part on the received policy information.

21. The article of manufacture of claim 20, wherein the remote device comprises a network access policy decision point (PDP).

22. The article of manufacture of claim 20, wherein the signed platform information associated with the network access grant comprises a posture signature and at least one of host posture information and/or firmware posture information of the host device.
